(19) United States
(12) Patent Application Publication
(10) Pub. No.: US 2025/0253734 A1
(43) Pub. Date: Aug. 7, 2025

(54) ELECTRIC MOTOR OF A MOTOR VEHICLE

(71) Applicant: Brose Fahrzeugteile SE & Co. Kommanditgesellschaft, Wuerzburg, Wuerzburg (DE)

(72) Inventors: Christoph EHEHALT-BOEHM, Kuernach (DE); Kevin KOCH, Fuerth (DE)

(73) Assignee: Brose Fahrzeugteile SE & Co. Kommanditgesellschaft, Wuerzburg, Wuerzburg (DE)

(21) Appl. No.: 19/191,685

(22) Filed: Apr. 28, 2025

Related U.S. Application Data
(63) Continuation of application No. PCT/EP2023/079546, filed on Oct. 24, 2023.

(30) Foreign Application Priority Data
Oct. 27, 2022 (DE) 10 2022 211 462.4

(51) Int. Cl. H02K 5/10; B62D 5/04; H02K 21/16

(52) U.S. Cl. CPC H02K 5/10; B62D 5/0406; H02K 21/16

(57) ABSTRACT

An electric motor having a housing with a partition wall between an electronics compartment and a motor compartment for accommodating a stator with a stator winding and a rotor which is shaft-mounted on a motor shaft. The partition wall has a central shaft or bearing opening for the motor shaft and a number of apertures for phase connections for electrical contacting of the stator winding with an electronic system. A cover element spanning the partition wall is arranged in the electronics compartment, which cover element has passage openings for the phase connections corresponding to the apertures in the partition wall.

This nonprovisional application is a continuation of International Application No. PCT/EP 2023/079546, which was filed on Oct. 24, 2023, and which claims priority to German Patent Application No. 10 2022 211 462.4, which was filed in Germany on Oct. 27, 2022, and which are both herein incorporated by reference.

### BACKGROUND OF THE INVENTION

### Field of the Invention

The present invention relates to an electric motor of a motor vehicle, in particular a steering motor, having a housing with a partition wall with a number of apertures for phase connections between an electronics compartment and a motor compartment for a stator and rotor.

### Description of the Background Art

An electric motor is known, for example, from DE 10 2020 214 597 A1, which corresponds to US 2023/0291283, which is incorporated herein by reference.

Motor vehicles often have a large number of electromotive variable speed drives, such as window regulators or seat variable speed drives, in order to move a corresponding adjustment part. To simplify a steering movement in the motor vehicle, electric steering (power steering) is used, for example. In this case, an electric motor (steering motor) usually acts on a steering line rotating during steering, by means of which a rack is moved transversely, which in turn is coupled to the wheels of the motor vehicle which are to be moved during steering. By means of the electric motor, an unintentional steering angle is also avoided when controlled appropriately, for example, for which the angular movement of the steering wheel of the motor vehicle is monitored.

The electric motor may be brushed or designed as a brushless direct current motor (BLDC), for which purpose it has interconnected electrical coils which are powered by an electronic system. A short circuit of individual electrical coils, for example due to unintentional contact with an electrically conductive component, can lead to a blockage of the electric motor, so that steering of the motor vehicle is no longer possible or at least more difficult. To avoid such a situation, the individual components of the electric motor are generally arranged in a common (moto) housing, which is designed to be comparatively robust. Usually, a metal is used as the material for the housing.

Due to comparatively large (manufacturing) tolerances of individual motor components and/or their distances to each other, as well as to avoid impairing the functioning of the electric motor, a correspondingly large installation space must be provided within the housing, which is often undesirable, for example, due to the space required for the electric motor. In addition, it is necessary that the individual components of the (motor) electronic system are protected from particles in order to avoid impairing the functioning of the electronic system.

For example, in the event of leaks and particle migration from the motor side to the electronic system, there is a risk of a short circuit in the electronic system. This risk, which exists, for example, due to tolerances and reduced distances between individual components, is increased by the fact that the electronic system or control unit are contacted to the motor via insulation displacement connections or contacts as a technique frequently used in the automotive industry. In this context, the coil or phase connections are typically routed directly by the stator winding, preferably constructed of interconnected coils, to corresponding counter contacts of the electronic system without particle and/or moisture protection.

### SUMMARY OF THE INVENTION

It is therefore an object of the invention to provide a particularly suitable electric motor of a motor vehicle, wherein in particular short circuits of the or in the (motor) electronic system are to be avoided.

For this purpose, the electric motor can have a housing, in particular a hollow cylindrical one, with a partition wall between an electronics compartment and a motor compartment as well as a cover element, especially as particle and/or moisture protection for the (motor) electronic system. The motor compartment of the housing is used to accommodate a stator with a stator winding and a rotor, which is shaft-mounted on a motor shaft or rotationally fixed. The partition wall has a central bearing opening for the motor shaft and a number of apertures for phase connections for electrical contacting the stator winding with the electronic system. The cover element, which is suitably arranged in the electronics compartment, can span the partition wall or preferably covers it completely or over the entire surface. The cover element can have passage openings for the phase connections corresponding to the apertures in the partition wall. In an advantageous design, a sealing element can be provided in the passage openings of the cover element that at least partially surrounds the phase connections.

The electric motor may be brushless and preferably a brushless DC motor (BLDC). Conveniently, the electric motor can be a component of an auxiliary unit, such as a variable speed drive, of a motor vehicle. The variable speed drive comprises an adjustment part which is moved along an adjustment range by means of the electric motor during operation. Preferably preferred, the electric motor acts as the steering drive (steering motor) of the motor vehicle. The adjustment part is in particular a steering line by means of which a rack is moved. Alternatively, the adjustment part is the rack itself, by means of which at least one of the wheels of the motor vehicle is swiveled around an essentially perpendicular axis.

The invention is based on the assumption that the risk of short circuits in the electronic system of a brushless, electronically commutated electric motor can be minimized as far as possible if distance deviations and/or movements between individual motor or electronic components and/or (manufacturing) tolerances are compensated by means of a mechanical interface between the electrical system and the other motor components. The mechanical interface should be as particle-and/or moisture-proof as possible.

The mechanical interface should have a component made of a comparatively hard material, in particular to create a tight fit within the housing, and a component made of a comparatively soft material, especially on existing sealing surfaces, preferably for sealing the electronic system from the motor components and/or to compensate for tolerances and movements, for example due to temperature fluctuations or mechanical movements or shocks.

The mechanical interface in the form of the cover element can be designed as a cover inside the electronics compartment of the housing, which prevents (leakage) contamination on the electronics-system side. The cover element should preferably be a plastic cover with a sealing effect, especially in relation to the motor compartment and suitably also at the phase connections, in order to prevent the ingress of foreign particles, liquids and/or lubricating oil into the electronics compartment of the housing as reliably as possible.

The cover element should also be used to ensure the functional reliability of an existing rotor positioning sensor or encoder, for example a ring magnet connected to the motor shaft. In addition, the cover element should serve the purpose of providing the most reliable or at least sufficient stability possible for contacts or ladder frames connected by a motor or stator-side connection unit to existing contacts, in particular insulation displacement contacts, of the electronic system (of the control unit), e.g., via apertures, holes or passages in a partition wall of the housing.

The cover element can have a disc-like base body and a cap edge that acts as a sealing ring. This can be formed of, in particular, an elastic plastic (elastomer). The base body can be formed, for example, of a comparatively hard plastic. Particularly preferably, the cover element can be an integral (one-piece) two-component part made of two plastics of different hardness (2K plastic component).

Appropriately, the cover, which is appropriately circular, fits tightly against an inner wall of the housing.

A sealing element that at least partially surrounds the phase connections can be provided in the passage openings of the cover element. Preferably, the sealing elements are connected to the cap edge of the cover element via, in particular radial, sealing bars.

The cover element can be provided and configured for the purpose of accommodating and/or covering a signal transmitter, in particular a ring magnet. For this purpose, the cover element can have an axially raised cap area forming a receiving space for the signal transmitter. The wave-proof signal transmitter, which is conveniently arranged at the end of the shaft, acts, for example, with a Hall sensor of the (motor) electronic system to detect speed and/or rotation direction or position of the motor shaft. In the case of a steering motor in particular, the angular movement of the steering wheel of the motor vehicle can thus be reliably monitored.

Appropriately, the cover element can have an axially raised cap section. This covers a ring-shaped receiving space provided in the partition wall of the housing. This surrounds the bearing opening of the partition wall in a ring and receives a spring washer which interacts with a shaft bearing, in particular with the inner and/or outer ring of a ball bearing. In the design of the cover element with the cap section used for receiving or covering the signal transmitter, the diameter of said cap section is smaller than that of the cap section spanning the annular receiving space of the partition wall to cover the spring washer. In this design of the cover element, it preferably has a two-tiered cap section, especially centrally.

Radially oriented support, centering and/or positioning ribs are suitably molded to a ring wall of the annular cap section of the cover element on the inside (inner wall side). By means of these ribs, a tight fit of the cover element is achieved on the partition wall and thus in the housing. In order to stabilize the cover element, preferably additionally, or to increase its rigidity, the cover element expediently has a number of support and/or stabilizing ribs that are in particular radially oriented or running on the outer side of the cap.

A separating element, especially foil-like, can be arranged between the partition wall and the stator. In particular, the separator is arranged parallel to the housing wall. By means of the separation element, the apertures and the housing wall are at least partially covered. Consequently, there is an additional component between the stator and the electronic system, wherein the separator is used to reduce the size, diameter, or clear width of the apertures. As a result, the passage of particles and/or liquids (lubricating oil) between the motor compartment and the electronics compartment is hampered. Such contamination can occur, for example, in the case of abrasion of components of the electric motor arranged in the motor compartment, or it may be present there after manufacturing (motor assembly).

The advantages achieved by the invention include, in particular, the fact that by means of a cover element as a mechanical interface in the housing of an electric motor, the occurrence of short circuits due to particles and liquids on the circuit board of an electronic system of the electric motor is averted in a particularly cost-effective way and without a significant increase in the mass of the motor assembly. In addition, it is possible to adapt to different tolerances in a reliable or effective manner without impairing the functionality of motor and/or electronic components. Furthermore, a cost reduction is provided for the housing of the electric motor by omitting a bearing seat cover for a spring washer for bearing preload or adjustment and by using the cover element as a bearing cover or also as a bearing plate. Furthermore, in addition to or due to the reduction of the risk of short circuits, the probability of failure of the electronic system of the electric motor is advantageously reduced.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows excerpts in an exploded view of an electric motor with a housing to accommodate a motor assembly and an electronic system as well as a cover element on the electronics-system side,

FIG. 2 shows in a longitudinal section, the housing with a partition wall between a motor compartment and an electronics compartment and with the cover element on the partition wall,

FIG. 3 shows in a longitudinal section, the housing with a motor-side switching unit (interconnect ring) and an electronic system-side cover element as well as with a motor shaft of the electric motor mounted in the partition wall and in a bearing shield,

FIGS. 4a and 4b show perspective representation of the cover element in a plan view or in a bottom view,

FIG. 5 shows a longitudinal section of the area of the partition wall in the electronics compartment of the housing of the electric motor, which is spanned by means of the cover element, and

FIG. 6 shows an electric steering system of a motor vehicle with an electric motor.

### DETAILED DESCRIPTION

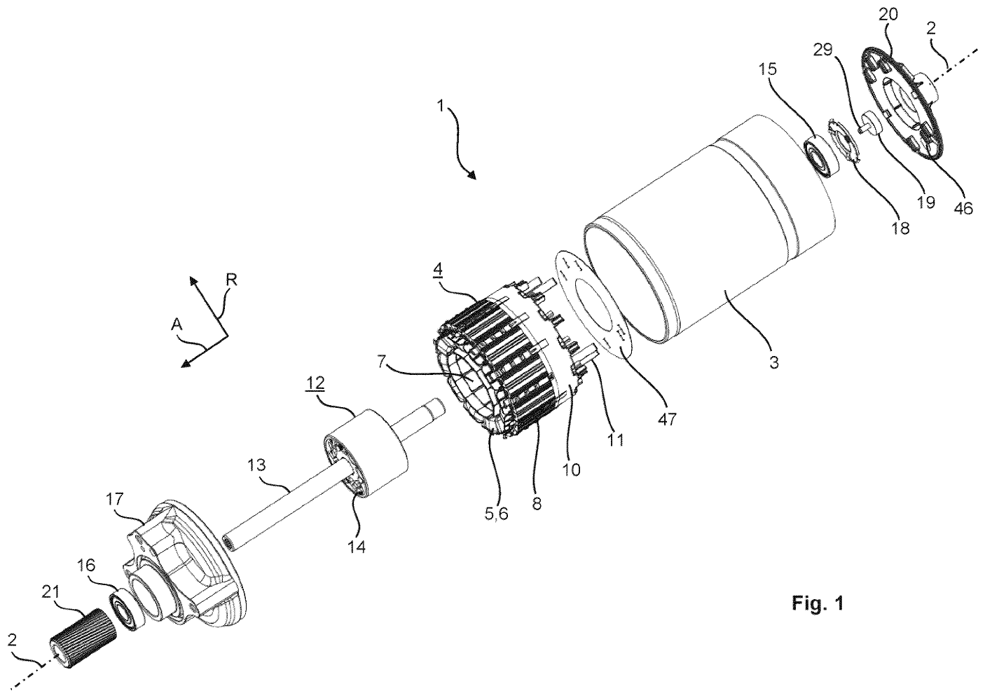

FIG. 1 shows the electric motor 1 in an exploded view, with the individual components pulled apart along a longitudinal axis 2. Indications such as axial or radial refer to the axial direction A parallel to the longitudinal axis 2 or to the radial direction R transverse to the longitudinal axis 2 shown in FIG. 1.

The electric motor 1 has a housing 3 which is preferably made of aluminum, for example by a die-casting or cold extrusion process. The housing 3 is preferably hollow cylindrical with a (circular) round base or cross-sectional area, wherein the cylinder axis coincides with the longitudinal axis.

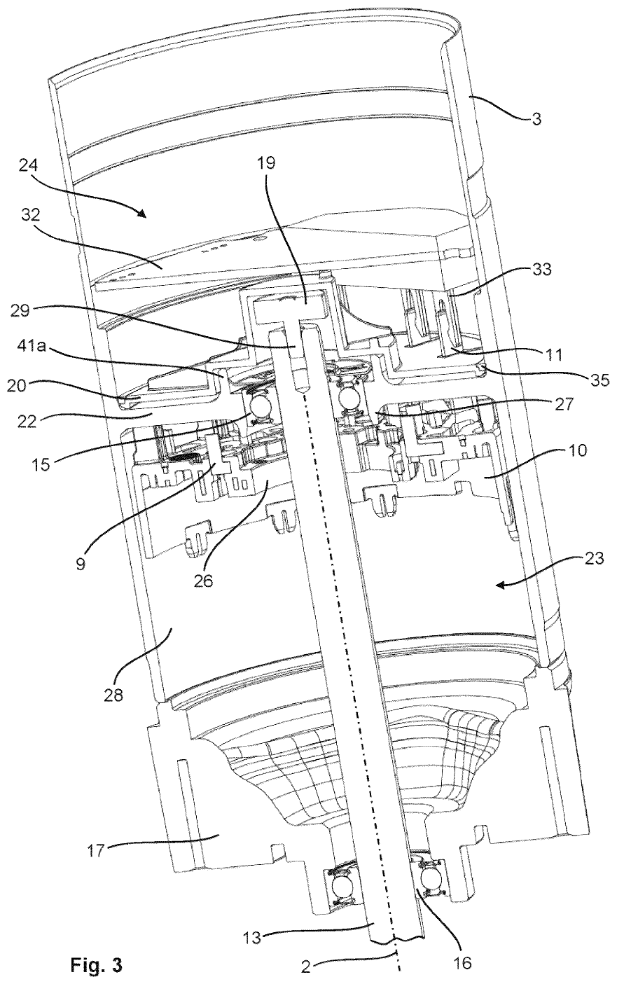

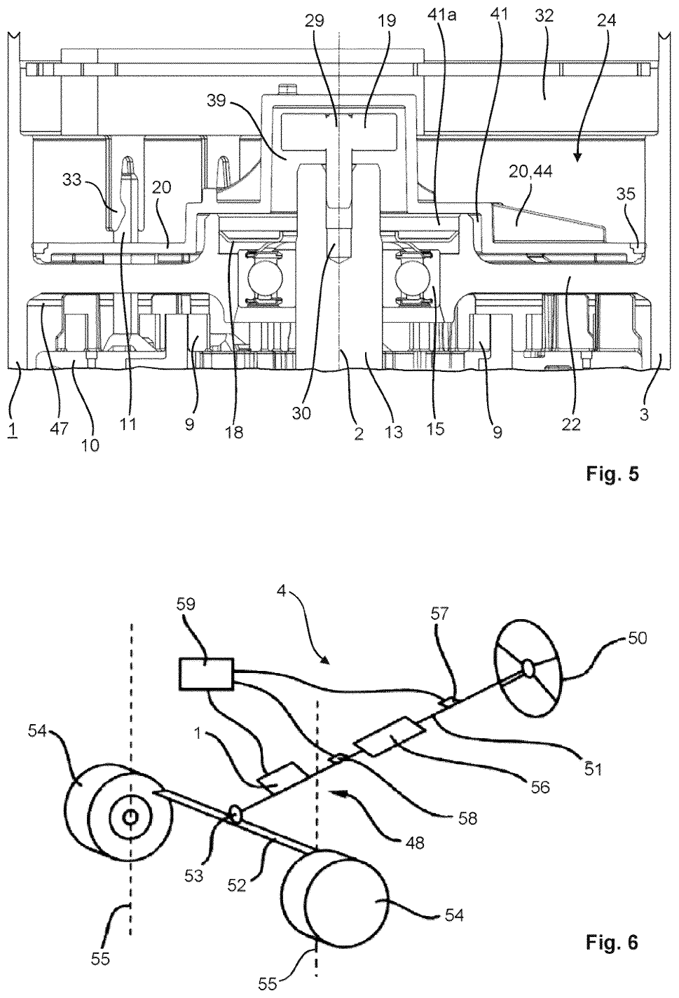

The (brushless) electric motor 1 also has a stator 4 with a stator winding (rotary field winding) 5. This is formed from coils 6, which are mounted on stator teeth 7 directed radially inwards, for example, of a stator base body 8 formed as a sheet metal stack and connected (interconnected) by means of an interconnect ring formed in particular from busbars 9 (FIGS. 3 and 5) as a switching unit 10 to phases, for example in a delta circuit. The coil ends of the stator winding 5 are routed into phase connections 11, which are preferably formed from busbar contacts and are expediently oriented axially or parallel to the longitudinal axis 2.

Furthermore, the electric motor 1 has a rotor 12, which is rotationally fixed on a motor shaft 13 or shaft-mounted. The rotor 12 surrounded by the stator 4 has, preferably on the circumferential side, a number of permanent magnets 14. The motor shaft 13 is supported by means of an A-side bearing 15, in particular a ball bearing, in the housing 3 and by means of a B-side bearing 16, in particular a ball bearing, in a bearing shield 17. The preferably lid-like bearing shield 17 is arranged on the A-side end of the housing 3 when it is mounted (FIG. 3). The B-side (ball) bearing 16 is mechanically pre-tensioned or adjusted by means of a (claw) spring washer 18. A signal transmitter 19 in the form of a ring magnet is used to determine the speed, direction of rotation and/or rotation position of the rotor 12. The electric motor 1 also has a cover element 20, which can preferably be inserted from the B-side of the housing 3. An output element 21, for example a pinion or a pulley, sits on the A-side on the motor shaft 13.

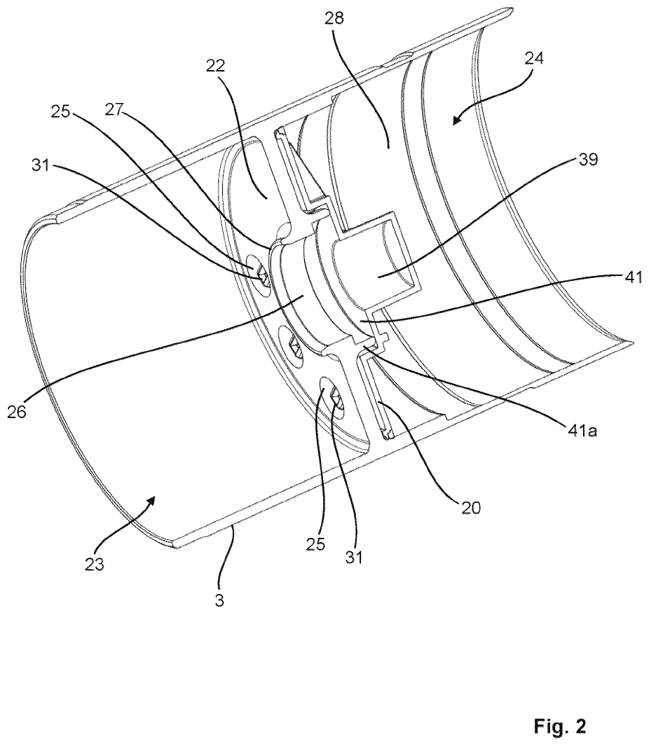

FIG. 2 shows the housing 3 of the electric motor 1 in a longitudinal section along the longitudinal axis 2. The inner side of the housing 3 has a partition wall 22 arranged perpendicular to the longitudinal axis 2, which is one-piece with the hollow cylindrical housing 3 and arranged within it. The partition wall 22 is arranged between the two ends of the hollow cylindrical housing 3, so that a motor compartment 23 and an electronics compartment 24 are formed, which are separated from each other by means of the partition wall 22. The partition wall 22 between the motor compartment 23 and the electronics compartment 24 has radially offset apertures 25 with a circular transverse section in the example. Centered with respect to the longitudinal axis 2, a recess is inserted into the partition wall 22 as a shaft or bearing opening 26, which is bounded or surrounded by means of a circumferential wall 27, which axially protrudes into the motor compartment 23 and is concentric to the longitudinal axis 2. In the electronics compartment 24, the cover element 20 is placed on the partition wall 22, which spans the partition wall 22 and fits tightly against the inner wall 28 of the housing 3.

FIG. 3 shows the housing 3 with a mounted (A-side) bearing shield 17 and a rotatably mounted motor shaft 13, as well as cover element 20 placed on the partition wall 22 on the electronics compartment side and a switching unit 10 arranged on the motor compartment side. Via the shaft or bearing opening 26, a shaft section or journal of the motor shaft 13 is routed into the electronics compartment 24. There, the signal transmitter 19 is shaft-mounted to the motor shaft 13 or connected in a rotationally fixed manner via a connecting element 29, which is located in an axial plug-in or joining opening 30 of the motor shaft 13 (FIG. 5). The phase connections 11 project beyond the passage openings 31 provided in the cover element 20, into the electronics compartment 24.

As can be seen in connection with FIG. 2, the passage openings 31 of the cover element 20 correspond or align with the apertures 25 of the partition wall 22. In the electronics compartment 24, a (motor) electronic system 32 is included, of which a printed circuit board with a counter contact 33 to one of the phase contacts or connectors 11 of the switching unit 10 is illustrated in FIG. 3. The counter contact 33 is preferably designed as an insulation displacement contact.

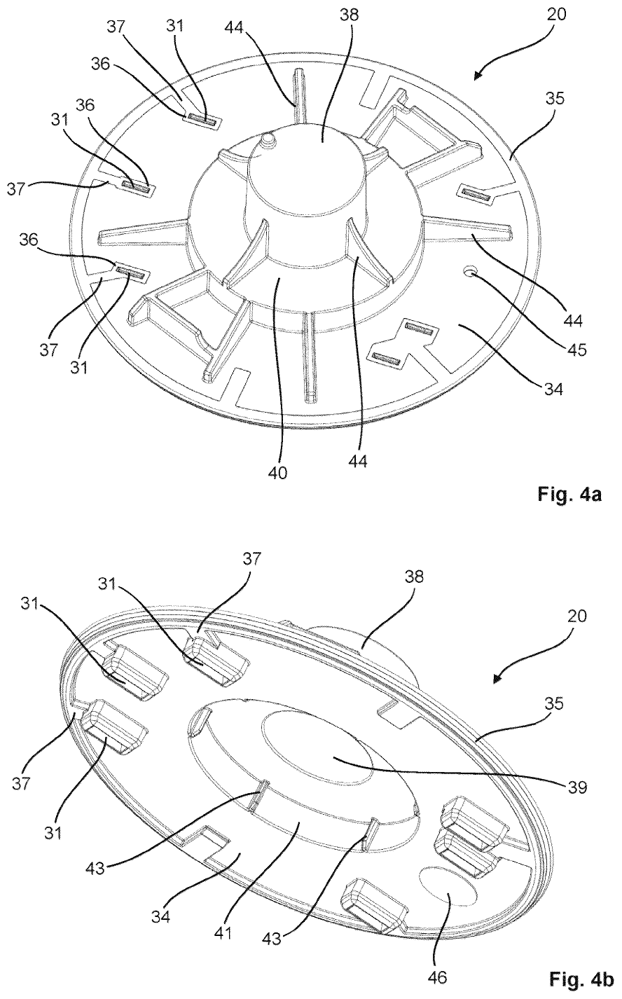

FIGS. 4a and 4b show the cover element 20 in different perspective representations. The cover element 20 is inserted into the electronics compartment 24 of the housing 3 in order to span the partition wall 22 and to cover it completely or over the entire surface. The passage openings 31 of the cover element 20, which correspond to the apertures 25 of the partition wall 22 provided for the phase connections 11, can be seen.

The cover element 20 has a disc-like or circular base body 34 with a cross-section and a cap edge 35 acting as a sealing ring or sealing lip. This includes an elastic plastic (elastomer). The base body 34 is made of a comparatively hard plastic. The cover element 20 is a two-component part made of two plastics of different hardness (2-component plastic part). With the circumferential, elastic cap edge 35, the cover element 20 fits tightly on an inner wall 28 of the housing 3. In addition, in the passage openings 31 of the cover element 20, the phase connections 11 are preferably provided with completely surrounding sealing elements 36, which are molded to the base body 34 in the passage openings 31. The sealing elements 36 are connected to the cap edge 35 of the cover element 20 via radial (sealing) bars 37 which are made of the same material as the cap edge 35 and the sealing elements 36.

The cover element 20 is designed to accommodate and cover the shaft-end signal transmitter 19. For this purpose, the cover element 20 has an axially raised cap area 38, forming a receiving space 39 for the signal transmitter 19. The shaft-mounted signal transmitter 19 at the end of the motor shaft 13 interacts in an unspecified manner with a sensor of the (motor) electronic system 32 for detection of speed and/or direction of rotation or position of the motor shaft 13.

The cover element 20 has an axially raised cap section 40, which covers a ring-shaped receiving space 41 provided in the partition wall 22 of the housing 3, which is surrounded by an axially raised wall protruding into the electronics compartment 24. This or the ring-shaped receiving space 41 surrounds the bearing opening 26 of the partition wall 22 in a ring shape and accommodates the spring washer 18 for the B-side bearing 15.

What can be seen is the diameter or clear width of the receiving space 41 of the cap section 40 larger than the diameter or clear width of the receiving space 39 of the cap area 38 of the cover element 20 and smaller than the diameter of its base body 34. Appropriately, the diameter of the receiving space 41 or the cap section 40 is about (48±3) % of the diameter of the base body 34. The diameter of the receiving space 39 or the cap area 38 is appropriately about (22±3) % of the diameter of the base body 34.

In the cap section 40 of the cover element 20, ribs 43 are molded to a ring wall 42 radially inwards on the inside of the wall. These enable the cover element 20 to be centered and the cover element 20 to be firmly seated on the partition wall 20 and thus in the housing 3. In order to stabilize the cover element 20 or to increase its rigidity, the cover element 20 has a number of radially oriented stabilization ribs 44 on the outer side. In the base body 34 of the cover element 20 is a degassing hole 45, which is covered on the inside with a membrane 46, in particular permeable to gas or vapor.

FIG. 5 shows the electric motor 1 in the area of the partition wall 22 with the cover element 20 arranged on top of it in the electronics compartment 24. The switching unit 10 can be seen with the busbars 9 and with the phase connections 11 engaging through the partition wall 22 and the cover element and protruding into the electronics compartment 11. On the side of the partition wall 22 facing the stator 4 or the switching unit 10, a foil-like separator 47 is arranged. This covers the apertures 25 in the partition wall 22 as well as the latter at least partially. With the separator 47, the size of the apertures 25 is reduced, which already makes it more difficult for particles and/or liquids (lubricating oil) to pass between the motor compartment 23 and the electronics compartment 24.

FIG. 6 shows a variable speed drive 48 of a motor vehicle 49 in a schematically simplified manner in the form of an electric steering (power steering). The motor vehicle 49 comprises a steering wheel 50, which is coupled by means of a steering rod 51 to a rack 52 or a pinion 53. The rack 52 is coupled with front wheels 54 which are to be swiveled about an axis 55 running essentially perpendicular when the steering wheel 50 is turned. The steering rod 51 is divided into two parts, with the two parts connected to each other by means of a rod 56.

A first sensor 57 is assigned to the part of the steering rod 51 located between the rod 56 and the steering wheel 50 and a second sensor 58 is assigned to the part of the steering rod 51 located between the pinion 56 and the rod 56, which sensors are signally connected to a control unit 59. The electromotor, which is controlled by the control unit 59, is assigned to the part of the steering rod 51 located between the pinion 53 and the rod 56. Here, an angular offset between the two parts of the steering rod 51 is detected by means of the two sensors 58, 59 and thus a desired steering angle of the front wheels 54 is determined. If necessary, the electric motor 1 is energized to support the rotational movement of the steering rod 51.

In summary, the invention relates to an electric motor 1, having a housing 3 with a partition wall 22 between an electronics compartment 24 and a motor compartment 23, wherein the partition wall 22 has a number of apertures 25 for phase connections 11 for electrically contacting a stator winding 5 with an electronic system 32, and wherein a cover element 20 spanning the partition wall 22 is arranged in the electronics compartment 24, which cover element has apertures 31 for the phase connections 11 corresponding to the apertures 25 of the partition wall 22.

The invention is not limited to the embodiment described above. On the contrary, other variants of the invention can also be derived from it by the skilled person without departing from the subject-matter of the invention. Individual features described in context with the individual embodiments can also be combined with each other in other ways without departing from the subject matter of the invention.

What is claimed is:

1. An electric motor of a motor vehicle, in particular a steering motor, the electric motor comprising:
a housing having an electronics compartment and a motor compartment;
a partition wall arranged between the electronics compartment and the motor compartment that accommodates a stator having a stator winding and a rotor mounted on a motor shaft, the partition wall having a central shaft or bearing opening for the motor shaft and at least two apertures for phase connections for electrical contacting of the stator winding with an electronic system; and
a cover element arranged in the electronics compartment, the cover element spanning the partition wall and has passage openings for the phase connections corresponding to the apertures of the partition wall.

2. The electric motor according to claim 1, wherein the cover element bears sealingly against an inner wall of the housing.

3. The electric motor according to claim 1, wherein the cover element has a disc-like base body and has a cap edge that acts as a sealing ring, in particular made of an elastomer or an elastic plastic.

4. The electric motor according to claim 1, wherein in the passage openings of the cover element, a sealing element at least partially surrounding the phase connections is provided.

5. The electric motor according to claim 4, wherein the sealing element is connected to the cap edge of the cover element via a radial sealing bar.

6. The electric motor according to claim 1, wherein the cover element has an axially raised cap area forming a receiving space for a signal transmitter or a ring magnet connected with the motor shaft.

7. The electric motor according to claim 1, wherein the cover element comprises an axially raised cap section for covering a ring-shaped receiving space provided in the partition wall for a spring washer interacting with a bearing arranged in the shaft bearing opening of the partition wall or with the outer or inner ring of a ball bearing.

8. The electric motor according to claim 7, wherein radially oriented supporting, centering, and/or positioning ribs are molded on the inside of a ring wall of the ring-shaped receiving space of the cover element.

9. The electric motor according to claim 1, wherein on the outer side facing away from the partition wall, the cover element has at least two radially oriented, support and/or stabilizing ribs.

10. The electric motor according to claim 1, wherein a separator, in particular foil-like, is arranged between the partition wall and the stator, via which the apertures and the partition wall are at least partially covered.
